(19) United States
(12) Patent Application Publication
(10) Pub. No.: US 2010/0228923 A1
(43) Pub. Date: Sep. 9, 2010

(54) Memory system having multiple processors

(75) Inventor: Euicheol Lim, Hwaseong-si (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 12/657,508

(22) Filed: Jan. 22, 2010

(30) Foreign Application Priority Data
Mar. 6, 2009 (KR) 10-2009-0019267

(51) Int. Cl. G06F 12/00

(52) U.S. Cl. 711/147; 711/157; 711/E12.001; 711/E12.079

(57) ABSTRACT

A memory system includes multiple processors. The memory system includes first and second processors, a storage device and a controller. The storage device includes one or more banks which are respectively allocated to the first processor or the second processor. The controller controls the storage device to access a plurality of banks through an interleaving method when the plurality of banks are allocated to one processor. The memory system can improve performance and power efficiency.

### CROSS-REFERENCE TO RELATED APPLICATIONS

This U.S. patent application claims priority under 35 U.S.C. §119 to Korean Patent Application No. 10-2009-0019267, filed on Mar. 6, 2009, the contents of which are herein incorporated by reference in their entirety.

### BACKGROUND

1. Field

The present inventive concept relates to a memory system, and, more particularly, to a memory system including multiple processors.

2. Description of Related Art

A memory system may include two or more processors. For example, a mobile system includes a modem processor and an Application Processor (AP) (or a multimedia processor). The memory system including two or more processors requires at least two or more memories for driving the respective processors.

In the above-described example, the modem processor includes a NOR flash memory for storing codes and a Dynamic Random Access Memory (DRAM) for executing the codes. The application processor includes a NAND flash memory for storing codes and data, and a DRAM for executing the codes. The modem processor and the application processor exchange codes and data through a Universal Asynchronous Receiver Transmitter (UART), a Serial Peripheral Interface (SPI) or an SRAM interface.

However, a typical memory system requires a DRAM for executing codes for each processor. Consequently, the typical memory system includes many memories, which increases the cost. A method for using a dual port memory is being developed to solve these limitations. This method replaces DRAMs, which are respectively used in a typical modem and a typical application processor, with one dual port memory. However, there are still limitations in the data transmission speed of the dual port memory and power consumption of the dual port memory.

### SUMMARY

The present inventive concept provides a memory system which selectively applies an addressing method that is applied to each bank, thereby improving performance and power efficiency.

Embodiments of the inventive concept provide a memory system including: first and second processors; a storage device including one or more banks which are respectively allocated to the first processor or the second processor; and a controller controlling the storage device to access a plurality of banks through an interleaving method when the plurality of banks are allocated to one of the first processor and the second processor.

In one embodiment, the controller may control the storage device such that one or more banks which are allocated to different processors are accessed through a different method than the interleaving method. In one embodiment, the different method than the interleaving method is a linear addressing method. In one embodiment, the controller may provide an address for the linear addressing method to the storage device, wherein the address for the linear addressing method may have an order from a most significant bit to a least significant bit of a bank address, a row address and a column address.

In one embodiment, the controller may control the storage device to access one of all of the plurality of banks and a portion of the plurality of banks which are allocated to the one of the first processor and the second processor through the interleaving method. The controller may control the storage device such that rows of the banks are simultaneously activated through the interleaving method. The controller may provide an address for the interleaving method to the storage device, wherein the address for the interleaving method may have an order from a most significant bit to a least significant bit of a row address, a bank address and a column address.

In one embodiment, the controller may include a register, wherein the register may store an addressing mode to be applied to each of the banks. In one embodiment, the register may further store the number of banks and a size of each bank.

In one embodiment, the storage device may include a bank which is allocated to the first processor and the second processor.

In one embodiment, the storage device may include first and second ports, wherein the first port may be connected to the first processor, and the second port may be connected to the second processor.

### BRIEF DESCRIPTION OF THE DRAWINGS

The foregoing and other features and advantages of the inventive concept will be apparent from the more particular description of preferred aspects of the inventive concept, as illustrated in the accompanying drawings in which like reference characters refer to the same parts throughout the different views. The drawings are not necessarily to scale, emphasis instead being placed upon illustrating the principles of the inventive concept. In the drawings, the thickness of layers and regions are exaggerated for clarity.

FIG. 1 is a block diagram illustrating a dual port memory according to an exemplary embodiment of the inventive concept.

FIG. 2 is a block diagram illustrating a memory system according to an exemplary embodiment of the inventive concept.

FIG. 3 is a diagram illustrating a linear addressing method according to an exemplary embodiment of the inventive concept.

FIG. 4 is a diagram illustrating an interleaving addressing method according to an exemplary embodiment of the inventive concept.

FIG. 5 is a diagram illustrating the structure of a register of FIG. 2 according to an exemplary embodiment of the inventive concept.

FIG. 6 is a table illustrating address modes in a memory system including four banks according to an exemplary embodiment of the inventive concept.

FIG. 7 is a diagram illustrating the addressing method of part (b) of FIG. 6 according to an exemplary embodiment of the inventive concept.

FIG. 8 is a table illustrating address modes in a memory system including four banks according to an exemplary embodiment of the inventive concept.

FIG. 9 a diagram illustrating a partial 4 bank addressing method, a partial 2 bank addressing method and a linear addressing method applied to an exemplary embodiment of the present inventive concept.

### DETAILED DESCRIPTION OF THE EMBODIMENTS

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. Reference numerals are indicated in detail in preferred embodiments of the inventive concept, and their examples are represented in reference drawings. In every possible case, like reference numerals are used for referring to the same or similar elements in the description and drawings.

Below, a memory system is used as one example for illustrating characteristics and functions of the inventive concept. However, those skilled in the art can easily understand other advantages and performances of the inventive concept according to the descriptions. The inventive concept may be embodied or applied through other embodiments. The detailed description may be modified according to viewpoints and applications, not being out of the scope, technical idea and other objects of the inventive concept.

A dual port memory has a shared memory in order to enable access by two processors. The two processors may access the shared memory through different ports, respectively. The two processors may perform reading and writing operations on the dual port memory through different ports.

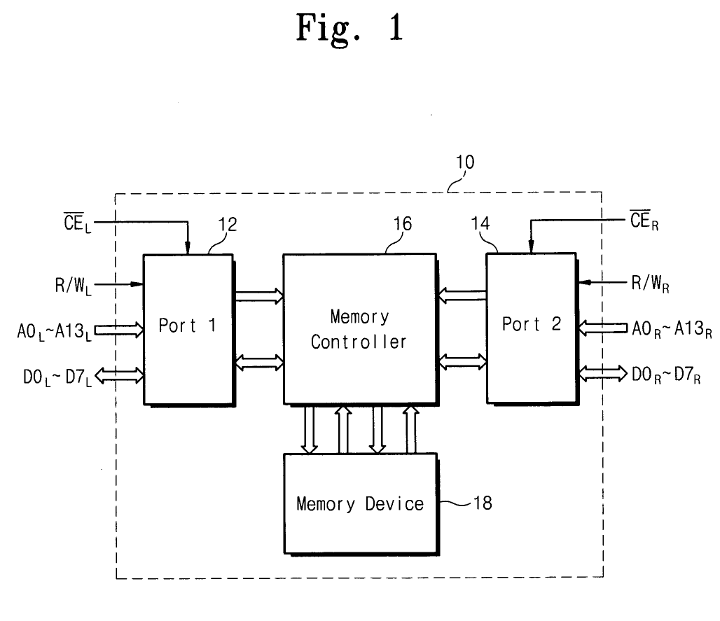

FIG. 1 is a block diagram illustrating a dual port memory.

Referring to FIG. 1, a dual port memory 10 includes two ports 12 and 14 that are connected to an external processor (not shown), a memory controller 16 for controlling signals that are inputted/outputted through the two ports 12 and 14, and a memory device 18 for storing/reading data that are inputted/outputted from/to the memory controller 16.

The ports 12 and 14 receives chip enable signals C̅E̅_̅{̅L̅}̅ and C̅E̅_̅{̅R̅}̅, respectively, that are applied from an external processor, reading and writing signals R/W_{L} and R/W_{R}, respectively, and addresses A0_{L}-A13_{L} and A0_{R}-A13_{R}, respectively, to transfer the received signals to the controller 16. The controller 16 receives the addresses A0_{L}-A13_{L} and A0_{R}-A13_{R}, and stores/reads data D0_{L}-D7_{L} and D0_{R}-D7_{R} in/from the memory 18.

A typical memory system requires a DRAM for executing the code of a modem and a DRAM for executing the code of an application processor. That is, a memory system using a plurality of typical processors separately requires a memory for executing the code of each of the processors. However, separately including a memory for executing the code of each of the processors is inefficient in the area and cost of a memory system. Moreover, this does not satisfy trends of decreasing the number of memories and cost, in that, a memory system is gradually becoming complicated, highly-integrated and miniaturized.

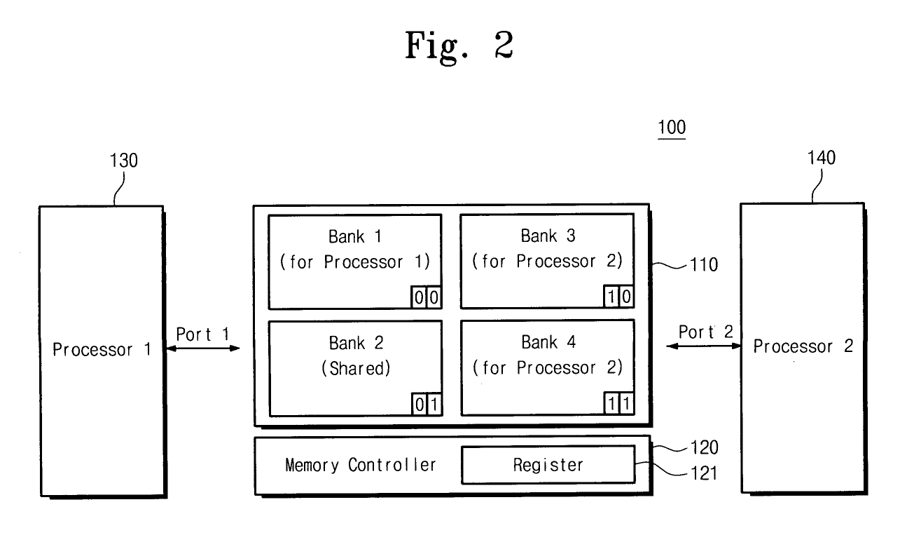

FIG. 2 is a block diagram illustrating a memory system according to an exemplary embodiment of the inventive concept.

Referring to FIG. 2, a memory system 100 according to an exemplary embodiment of the inventive concept includes a storage device 110, a memory controller 120, a first processor Processor 1 130, and a second processor Processor 2 140. The memory system 100 may be efficiently used in mobile systems such as portable phones and Personal Digital Assistants (PDA).

The storage device 110 includes a plurality of memory banks Bank1 to Bank4. The storage device 110 is connected to the first processor 130 and the second processor 140 through two ports Port1 and Port2, respectively. A first memory bank Bank1 is allocated to a first processor Processor1 130. Accordingly, the first processor Processor1 130 may store data, which have been processed and will be processed, in the first memory bank Bank1. A second memory bank Bank2 is allocated to the first processor Processor1 130 and a second processor Processor2 140. Therefore, the first processor Processor1 130 and the second processor Processor2 140 may store data, which have been processed and will be processed, in the second memory bank Bank2. Third and fourth memory banks Bank3 and Bank4 are allocated to the second processor Processor2 140.

The first port Port1 is connected to the first processor Processor1 130, and the second port Port2 is connected to the second processor Processor2 140. For example, the first processor Processor1 130 may be a modem, and the second processor Processor2 140 may be an application processor. The storage device 110 may be implemented with a Synchronous Dynamic Random Access Memory (SDRAM).

As described above, respective banks are allocated to different processors. Accordingly, in applying addressing for access, dividing the banks is required. As a result, a linear addressing method is used for respectively allocating banks to processors.

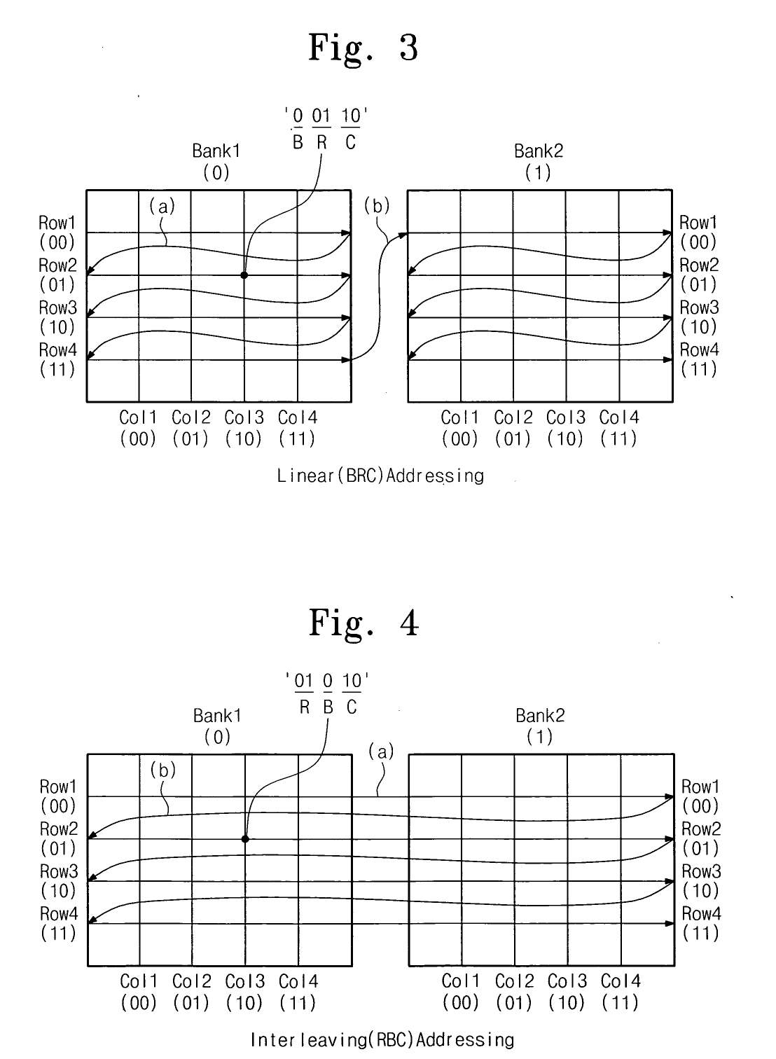

FIG. 3 is a diagram illustrates a linear addressing method.

Referring to FIG. 3, two banks Bank1 and Bank2 are exemplarily illustrated. Each of the banks is described as including four rows and four columns. However, the scope of the inventive concept is not limited thereto. Each of the banks may be an arbitrary number of rows and columns. A memory cell is disposed at the cross point between a row and a column.

In the linear addressing method, memory banks are sequentially accessed. That is, the second memory bank Bank2 is accessed after accessing the first memory bank Bank1. The linear addressing method may be called a Bank address-Row address-Column address (BRC) addressing method.

In the linear addressing method, the order of addressing is defined from a most significant bit to a least significant bit as bank address-row address-column address. For example, in the case of an address ‘00110’, ‘0’ is a bank address, ‘01’ is a row address, and ‘10’ is a column address. As illustrated in FIG. 3, the address ‘00110’ indicates a memory cell that is disposed at the cross point between the second row Row2 and third column Col3 of the first bank Bank1.

In the linear addressing method, a column address first increases by the sequential increase of an address. This is because the column address corresponds to the least significant bit. After a column address increases to the end, a row address increases. For example, an address next to an address ‘00011’ becomes ‘00100’. As an address increases, a row address increases by one and a column address is initialized. As a result, a row and a column to be accessed are changed. This is illustrated in part (a) of FIG. 3.

After a row address increases to the end, a bank address is changed. For example, an address next to an address ‘01111’ becomes ‘10000’. This denotes that a bank address increases by one and a row address and a column address are initialized. As a result, a bank, a row and a column to be accessed are changed. This is illustrated in part (b) of FIG. 3.

By the above-described method, a memory bank is sequentially accessed. In the linear addressing method, because only the row of one bank is activated at one time, a data transmission speed is limited. This can degrade the performance of the memory system. However, because only the row of one bank is activated at one time, a power necessary for the activation of a row is reduced. This can enhance the power efficiency of the memory system. As a result, the linear addressing method has limitations in performance and has advantages in power efficiency.

As described above with reference to FIG. 2, the third and fourth banks Bank3 and Bank4 are allocated to the second processor Processor2 140. Accordingly, in applying addressing for access, dividing the third and fourth banks Bank3 and Bank4 is required. As the third and fourth banks Bank3 and Bank4 are simultaneously accessed, a data transmission speed improves. As a result, an interleaving addressing method is used for simultaneously accessing the third and fourth banks Bank3 and Bank4.

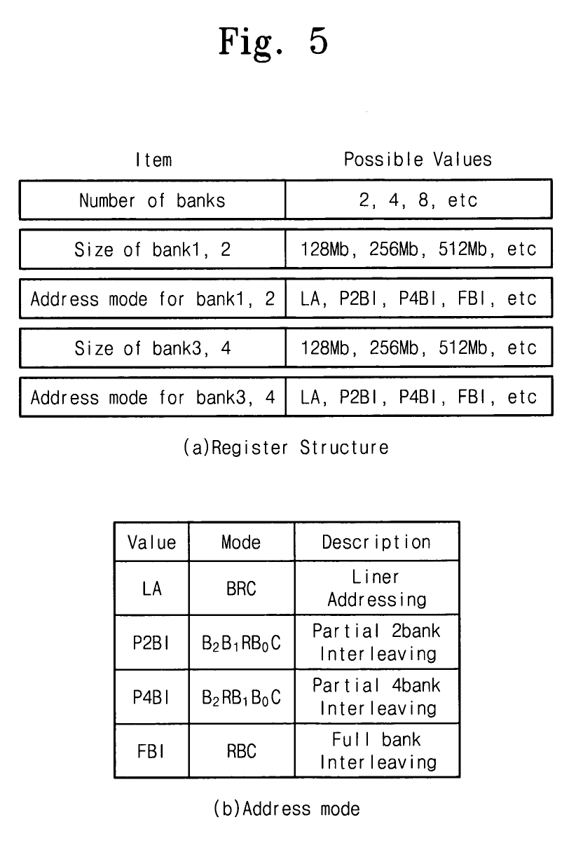

FIG. 4 is a diagram illustrating an interleaving addressing method.

Referring to FIG. 4, two banks Bank1 and Bank2 are exemplarily illustrated. Each of the banks is described as including four rows and four columns. However, the scope of the inventive concept is not limited thereto. Each of the banks may be an arbitrary number of rows and columns. A memory cell is disposed at the cross point between a row and a column.

In the interleaving addressing method, memory banks are simultaneously accessed. That is, the second row of the first memory bank Bank1 is accessed after accessing the first row of the first memory bank Bank1 and the first row of the second memory bank Bank2. The interleaving addressing method may be called a row address-bank address-column address (RBC) addressing method.

In the interleaving addressing method, the order of addressing is defined from a most significant bit to a least significant bit as row address-bank address-column address. For example, when an address is ‘01010’, ‘01’ is a row address, ‘0’ is a bank address, and ‘10’ is a column address. Referring to FIG. 4, the address ‘01010’ indicates a memory cell that is disposed at the cross point between the second row Row2 and third column Col3 of the first bank Bank1.

In the interleaving addressing method, a column address first increases by the sequential increase of an address. This is because the column address corresponds to the least significant bit. After a column address increases to the end, a bank address increases. For example, an address next to an address ‘00011’ becomes ‘00100’. As an address increases, a bank address increases by one and a column address is initialized. As a result, a bank and a column to be accessed are changed. This is illustrated in part (a) of FIG. 4.

After a column address increases to the end, a row address is changed. For example, an address next to an address ‘00111’ becomes ‘01000’. This denotes that a row address increases by one and a bank address and a column address are initialized. As a result, a bank, a row and a column to be accessed are changed. This is illustrated in part (b) of FIG. 4.

By the above-described method, two memory banks are simultaneously accessed. In the interleaving addressing method, because the rows of two banks are activated at one time, a data transmission speed improves. Accordingly, the performance of the memory system can be enhanced. However, because the rows of two banks are activated at one time, a power necessary for the activation of a row increases. This may increase the power consumption of the memory system. As a result, the interleaving addressing method has advantages in performance and has limitations in power efficiency.

In an exemplary embodiment of the inventive concept, different addressing methods may be applied to respective banks. For example, the linear addressing method may be applied to the first bank that is allocated to the first processor Processor1 130, and the interleaving addressing method may be applied to the third and fourth banks that are allocated to the second processor Processor2 140.

The memory controller 120 in FIG. 2 includes a register 121. The memory controller 120 may determine an addressing method to be applied to each bank on the basis of the register 121. The structure of the register 121 will be described below in detail with reference to the accompanying drawings.

FIG. 5 is a diagram illustrating the structure of the register of FIG. 2.

Referring to part (a) of FIG. 5, the register 121 stores the number of banks in the storage device, the size of each bank and an address mode for each bank. The number of banks may be 2, 4 and 8. The size of a bank may be 128 Mb, 256 Mb and 512 Mb. An address mode may include linear addressing, partial 2 bank interleaving, partial 4 bank interleaving, and full bank interleaving.

Referring to part (b) of FIG. 5, the linear addressing method sequentially accesses all banks. The linear addressing method may be called BRC addressing. As described above, in the BRC addressing method, the order of addressing is defined from a most significant bit to a least significant bit as a bank address-row address-column address.

In the linear addressing method, a column address first increases by the sequential increase of an address. This is because the column address corresponds to the least significant bit. After a column address increases to the end, a row address increases. After a row address increases to the end, a bank address increases. Through this method, banks may be sequentially accessed.

A partial 2 bank interleaving method accesses the rows of two banks at the same time. As an example of the partial 2 bank interleaving method, there is a B₂B₁RB₀C addressing method. In the B₂B₁RB₀C addressing method, the order of addressing is defined from a most significant bit to a least significant bit as first bank address-second bank address-row address-third bank address-column address. Furthermore, one bank is indicated by first to third bank addresses.

For example, in the case of an address ‘0110001’, a first bank address is ‘0’, a second bank address is ‘1’ and a third bank address is ‘0’. As a result, a bank address becomes ‘010’. This indicates the third bank. A row address is ‘10’, and a column address is ‘01’. Therefore, the address ‘0110001’ indicates a memory cell that is disposed at the cross point between the third row Row3 and second column Col2 of the third bank Bank3.

In the Partial 2 bank interleaving method, a column address first increases by the sequential increase of an address. This is because the column address corresponds to the least significant bit. After a column address increases to the end, the third bank address increases. For example, an address next to an address ‘0000011’ becomes ‘0000100’. This denotes that a bank address increases by one and a column address is initialized. As a result, a bank and a column to be accessed are changed.

After a column address increases to the end, a row address is changed. For example, an address next to an address ‘0000111’ becomes ‘0001000’. This denotes that a row address increases by one and a column address is initialized. As a result, a bank, a row and a column to be accessed are changed.

After a column address again increases to the end, a second bank address is changed. For example, an address next to an address ‘0011111’ becomes ‘0100000’. This denotes that a bank address increases by one and a row address and a column address are initialized. As a result, a bank, a row and a column to be accessed are changed.

In the above-describe example, because a 3-bit bank address is used, eight banks may be designated. Moreover, interleaving access for two banks among the eight banks may be performed through the partial 2 bank interleaving method. As a result, performance and power efficiency can improve through partial interleaving access.

Referring again to part (b) of FIG. 5, a partial 4 bank interleaving method accesses the rows of four banks at the same time. As an example of the partial 4 bank interleaving method, there is a B₂RB₁B₀C. addressing method. In the B₂RB₁B₀C addressing method, the order of addressing is defined from a most significant bit to a least significant bit as first bank address-row address-second bank address-third bank address-column address.

One bank is indicated by first to third bank addresses. For example, in the case of an address ‘0101001’, a first bank address is ‘0’, a second bank address is ‘1’ and a third bank address is ‘0’. As a result, a bank address becomes ‘010’. This indicates the third bank. A row address is ‘10’, and a column address is ‘01’. Therefore, the address ‘0101001’ indicates a memory cell that is disposed at the cross point between the third row Row3 and second column Col2 of the third bank Bank3.

In the Partial 4 bank interleaving method, a column address first increases by the sequential increase of an address. This is because the column address corresponds to the least significant bit. After a column address increases to the end, the third bank address increases. For example, an address next to an address ‘0000011’ becomes ‘0000100’. This denotes that a bank address increases by one and a column address is initialized. As a result, a bank and a column to be accessed are changed.

After a column address again increases to the end, a bank address is changed. For example, an address next to an address ‘0000111’ becomes ‘0001000’. This denotes that a bank address increases by one and a column address is initialized. As a result, a bank and a column to be accessed are changed.

After a row address increases to the end, a first bank address is changed. For example, an address next to an address ‘0111111’ becomes ‘1000000’. This denotes that a bank address increases by one and a row address and a column address are initialized. As a result, a bank, a row and a column to be accessed are changed.

In the above-describe example, because a 3-bit bank address is used, eight banks may be designated. Moreover, interleaving access for four banks among the eight banks may be performed through the partial 4 bank interleaving method. As a result, performance and power efficiency can improve through partial interleaving access.

Referring again to part (b) of FIG. 5, full bank interleaving accesses all banks at the same time. Full bank interleaving may be called RBC addressing. In the RBC addressing method, the order of addressing is defined from an upper bit to row address-bank address-column address.

In the full bank interleaving method, a column address first increases by the sequential increase of an address. This is because the column address corresponds to the least significant bit. After a column address increases to the end, a bank address increases. After a bank address increases to the end, a row address increases.

As described above, depending on the case, an addressing method may be selected. When a high speed is required in the driving of a memory system, the full bank interleaving method is the most useful. On the other hand, when a low power is required in the driving of the memory system, the linear addressing method is the most useful. Moreover, when the memory system requires a middle speed and middle power consumption, the partial interleaving method is appropriate.

In an exemplary embodiment of the inventive concept, by changing the setting of the register 121 in the memory controller 120, an addressing method to be applied may be changed. Accordingly, a user may freely change the addressing method, depending on the case.

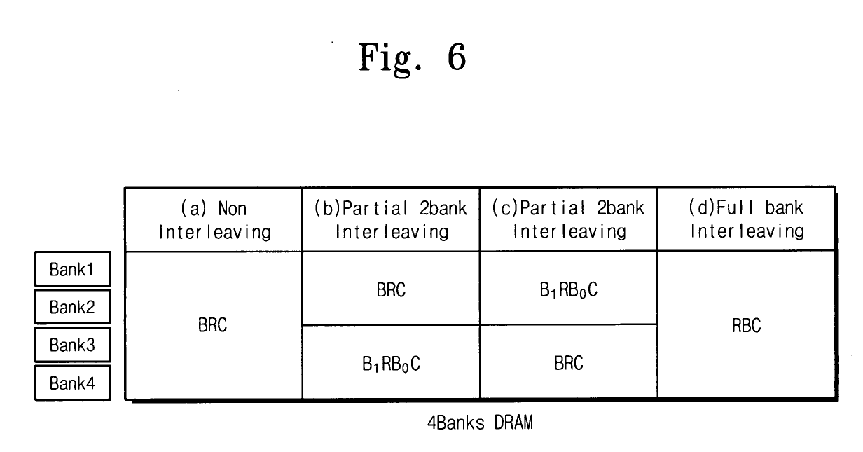

FIG. 6 is a table illustrating address modes in a memory system including four banks. Part (a) of FIG. 6 corresponds to a case in which the interleaving method is not applied. Because the linear addressing method, namely, BRC addressing, is applied to first to fourth banks, the first to fourth banks Bank1 to Bank4 are sequentially, independently accessed.

Part (b) of FIG. 6 corresponds to a case in which the partial 2 bank interleaving method is applied to the third and fourth banks Bank3 and Bank4. Because BRC addressing is applied to the first and second banks Bank1 and Bank2, the first and second banks Bank1 and Bank2 are sequentially, independently accessed. Moreover, because B₁RB₀C addressing is applied to the third and fourth banks Bank3 and Bank4, the third and fourth banks Bank3 and Bank4 are simultaneously accessed.

Part (c) of FIG. 6 corresponds to a case in which the partial 2 bank interleaving method is applied to the first and second banks Bank1 and Bank2. Because B₁RB₀C addressing is applied to the first and second banks Bank1 and Bank2, the first and second banks Bank1 and Bank2 are simultaneously accessed. Moreover, because BRC addressing is applied to the third and fourth banks Bank3 and Bank4, the third and fourth banks Bank3 and Bank4 are sequentially, independently accessed. This will be described below in detail with reference to the accompanying drawings.

Part (d) of FIG. 6 corresponds to a case in which the full bank interleaving method is applied to the first to fourth banks Bank1 to Bank4. Because BRC addressing is applied to the first to fourth banks Bank1 to Bank4, the first to fourth banks Bank1 to Bank4 are simultaneously accessed.

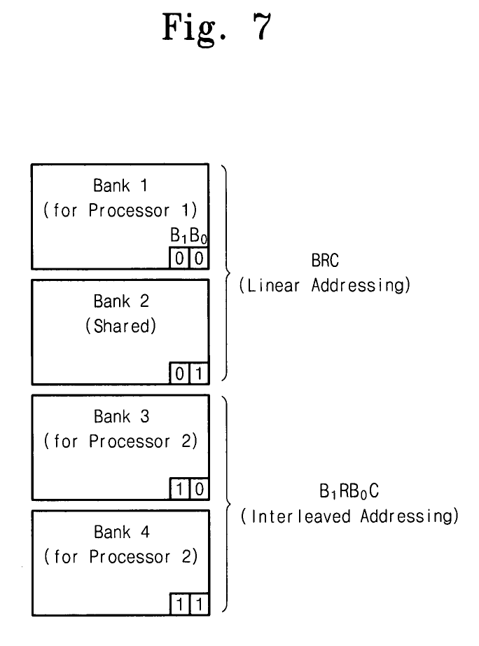

FIG. 7 is a diagram illustrating the addressing method of part (b) of FIG. 6.

Referring to FIG. 7, because the linear addressing method, namely, BRC addressing is applied to the first and second banks Bank1 and Bank2, the first and second banks Bank1 and Bank2 are independently accessed. As illustrated in FIG. 2, the first bank Bank1 may be allocated to the first processor Processor1 130. The processor Processor1 130 may independently access the first bank Bank1 through BRC addressing.

The second bank Bank2 may be allocated to the first and second processors Processor1 130 and Processor2 140. In other words, the first and second processors Processor1 130 and Processor2 140 may share the second bank Bank2. Because BRC addressing is applied, the first processor Processor1 130 or the second processor Processor2 140 may access independently the first bank Bank1.

As illustrated in FIG. 2, the third and fourth banks Bank3 and Bank4 may be allocated to the second processor Processor2 140. Because the interleaving addressing method, namely, B₁RB₀C addressing, is applied to the third and fourth banks Bank3 and Bank4, the second processor Processor2 140 may simultaneously access the third and fourth banks Bank3 and Bank4. As described above, by selectively applying the linear addressing method and the interleaving addressing method to each bank, the performance and power efficiency of the memory system can improve.

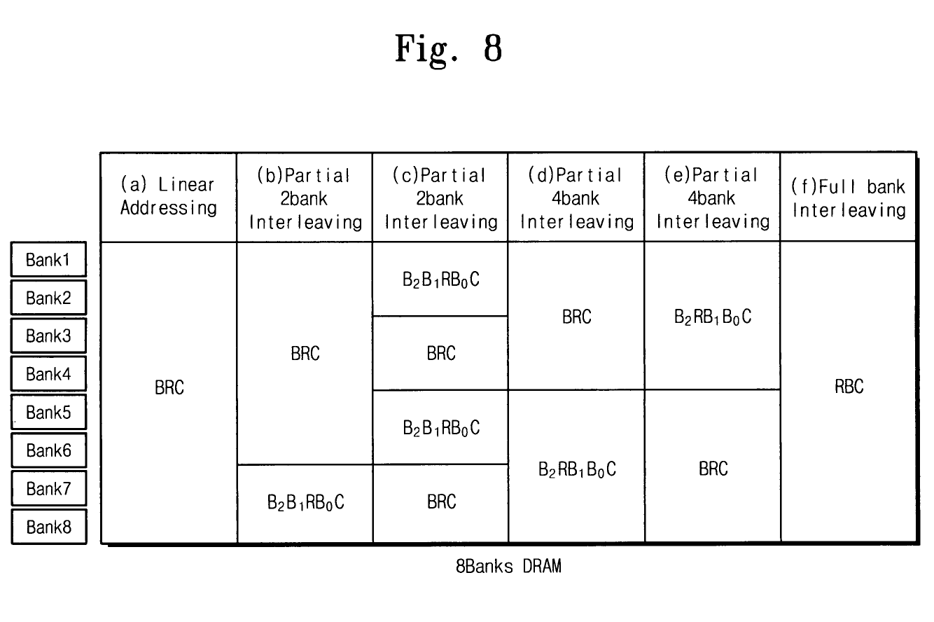

FIG. 8 is a table illustrating address modes in a memory system including four banks. However, the scope of the inventive concept is not limited to this. An exemplary embodiment of the inventive concept may be apparently applied to a memory system including an arbitrary number of banks.

Part (a) of FIG. 8 corresponds to a case in which the interleaving method is not applied. Because the linear addressing method, namely, BRC addressing is applied to first to eighth banks, the first to eighth banks Bank1 to Bank8 are sequentially, independently accessed.

Part (b) of FIG. 8 corresponds to a case in which the partial 2 bank interleaving method, namely, B₂B₁RB₀C addressing is applied to the seventh and eighth banks Bank7 and Bank8. Because the linear addressing method, namely, BRC addressing, is applied to the first to sixth banks Bank1 to Bank6, the first to sixth banks Bank1 to Bank6 are independently accessed. Moreover, because B₂B₁RB₀C addressing is applied to the seventh and eighth banks Bank7 and Bank8, the seventh and eighth banks Bank7 and Bank8 are simultaneously accessed.

Part (c) of FIG. 8 corresponds to a case in which the partial 2 bank interleaving method, namely, B₂B₁RB₀C addressing, is applied to the first and second banks Bank1 and Bank2 and the fifth and sixth banks Bank5 and Bank6. Because B₂B₁RB₀C addressing is applied to the first and second banks Bank1 and Bank2, the first and second banks Bank1 and Bank2 are simultaneously accessed. Because the linear addressing method, namely, BRC addressing, is applied to the third and fourth banks Bank3 and Bank4, the third and fourth banks Bank3 and Bank4 are independently accessed. Because B₂B₁RB₀C addressing is applied to the fifth and sixth banks Bank5 and Bank6, the fifth and sixth banks Bank5 and Bank6 are simultaneously accessed. Because BRC addressing is applied to the seventh and eighth banks Bank7 and Bank8, the seventh and eighth banks Bank7 and Bank8 are independently accessed.

Part (d) of FIG. 8 corresponds to a case in which partial the 4 bank interleaving method, namely, B₂RB₁B₀C addressing, is applied to the fifth to eighth banks Bank5 to Bank8. Because the linear addressing method, namely, BRC addressing, is applied to the first to fourth banks Bank1 to Bank4, the first to fourth banks Bank1 to Bank4 are simultaneously accessed. Moreover, because B₂RB₁B₀C addressing is applied to the fifth to eighth banks Bank5 to Bank8, the fifth to eighth banks Bank5 to Bank8 are simultaneously accessed.

Part (e) of FIG. 8 corresponds to a case in which the partial 4 bank interleaving method, namely, B₂RB₁B₀C addressing, is applied to the first to fourth banks Bank1 to Bank4. Because B₂RB₁B₀C addressing is applied to the first to fourth banks Bank1 to Bank4, the first to fourth banks Bank1 to Bank4 are simultaneously accessed. Moreover, because the linear addressing method, namely, BRC addressing, is applied to the fifth to eighth banks Bank5 to Bank8, the fifth to eighth banks Bank5 to Bank8 are independently accessed.

Part (f) of FIG. 8 corresponds to a case in which the full bank interleaving method, namely RBC addressing, is applied to the first to eight banks Bank1 to Bank8. Because RBC addressing, or RB₂B₁B₀C addressing, is applied to the first to eight banks Bank1 to Bank8, the first to eight banks Bank1 to Bank8 are simultaneously accessed.

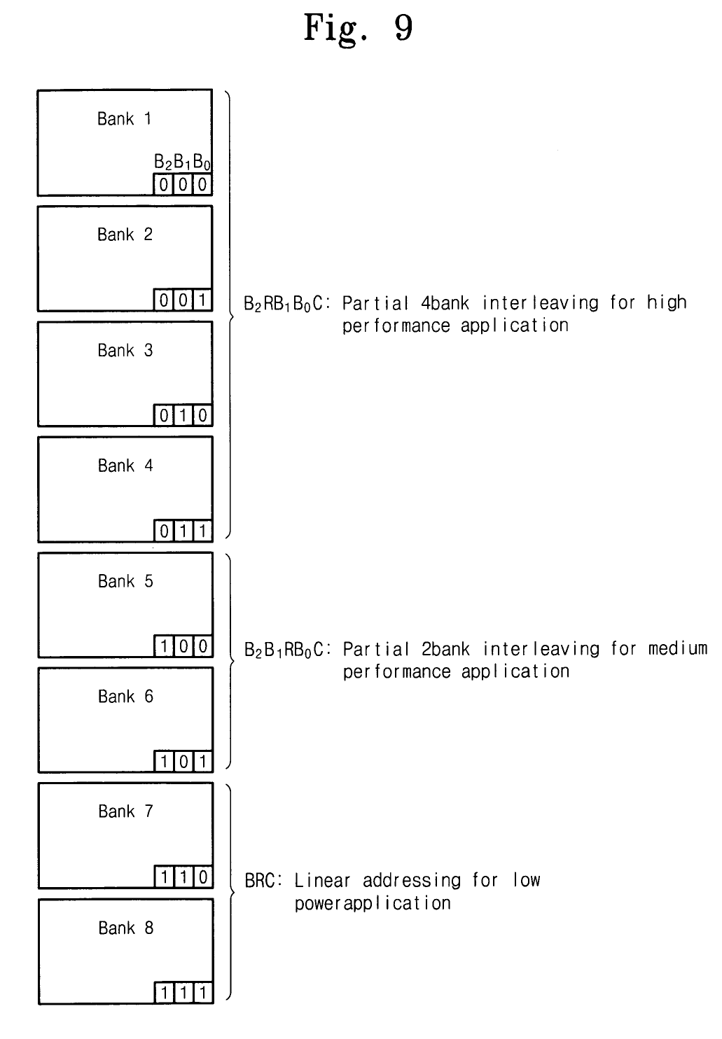

FIG. 9 a diagram for describing exemplary embodiments of the inventive concept to which all the partial 4 bank addressing method, the partial 2 bank addressing method and the linear addressing method are applied.

Referring to FIG. 9, because the partial 4 bank addressing method, namely, B₂RB₁B₀C addressing, is applied to the first to fourth banks Bank1 to Bank4, the first to fourth banks Bank1 to Bank4 may be simultaneously accessed. The partial 4 bank addressing method allows for a high performance application. For example, the first to fourth banks Bank1 to Bank4 may be allocated to the second processor Processor2 140. The second processor Processor2 140 may simultaneously access the first to fourth banks Bank1 to Bank4 through B₂RB₁B₀C addressing. Moreover, the fifth and sixth banks Bank5 and Bank6 may be allocated to the first processor Processor1 130. The first processor Processor1 130 may simultaneously access the fifth and sixth banks Bank5 and Bank6 through the partial 2 bank addressing method, namely, B₂B₁RB₀C addressing. The partial 2 bank addressing method allows for a medium performance application.

The seventh and eighth banks Bank7 and Bank8 may be allocated to the first and second processors Processor1 130 and Processor2 140. That is, the first and second processors Processor1 130 and Processor2 140 may share the seventh and eighth banks Bank7 and Bank8. Because the linear addressing method, namely, BRC addressing, is applied to the seventh and eighth banks Bank7 and Bank8, the first and second processors Processor1 130 and Processor2 140 may independently access the seventh and eighth banks Bank7 and Bank8, respectively. The linear addressing method allows for a low power application. As described above, by selectively applying the linear addressing method and the interleaving addressing method to each memory bank, the performance and power efficiency of the memory system can improve.

According to exemplary embodiments of the inventive concept, the memory system can improve performance and power efficiency.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A memory system, comprising:
first and second processors;
a storage device comprising one or more banks which are respectively allocated to at least one of the first processor and the second processor; and
a controller controlling the storage device to access a plurality of banks through an interleaving method when the plurality of banks are allocated to one of the first processor and the second processor.

2. The memory system of claim 1, wherein the controller controls the storage device such that one or more banks which are allocated to different processors are accessed through a different method than the interleaving method.

3. The memory system of claim 2, wherein the different method than the interleaving method is a linear addressing method.

4. The memory system of claim 3, wherein the controller provides an address for the linear addressing method to the storage device, wherein the address for the linear addressing method has an order from a most significant bit to a least significant bit of a bank address, a row address and a column address.

5. The memory system of claim 1, wherein the controller controls the storage device to access one of all of the plurality of banks or a portion of the plurality of banks which are allocated to one processor through an interleaving method.

6. The memory system of claim 5, wherein the controller controls the storage device such that rows of the plurality of banks are simultaneously activated through the interleaving method.

7. The memory system of claim 5, wherein the controller provides an address for the interleaving method to the storage device, wherein the address for the interleaving method has an order from a most significant bit to a least significant of a row address, a bank address and a column address.

8. The memory system of claim 1, wherein the controller comprises a register,
wherein the register stores an addressing mode to be applied to each of the banks.

9. The memory system of claim 8, wherein the register further stores a number of banks in the storage device and a size of each bank in the storage device.

10. The memory system of claim 1, wherein the storage device comprises a bank which is allocated to the first processor and the second processor.

11. The memory system of claim 1, wherein the storage device comprises first and second ports,
wherein the first port is connected to the first processor, and the second port is connected to the second processor.
